(19) United States
(12) Patent Application Publication
(10) Pub. No.: US 2021/0178528 A1
(43) Pub. Date: Jun. 17, 2021

(54) Trackless Welding Carriage With Guide Wheel

(71) Applicant: Titan Trailers Inc., Delhi (CA)

(72) Inventors: Michael Kloepfer, Delhi (CA); Trever Lorne Howden, Delhi (CA)

(73) Assignee: Titan Trailers Inc., Delhi, ON (CA)

(21) Appl. No.: 17/256,567

(22) PCT Filed: Jun. 28, 2019
(86) PCT No.: PCT/CA2019/050902

§ 371 Date: Dec. 28, 2020

Related U.S. Application Data
(60) Provisional application No. 62/691,063, filed on Jun. 28, 2018.

(51) Int. Cl. B23K 37/02; B23K 37/04

(52) U.S. Cl. CPC B23K 37/0282; B23K 37/0408; B23K 37/0294; B23K 37/0211

(57) ABSTRACT

A self-propelled welding carriage has a body supported by a wheeled suspension having a plurality of wheels including a carriage guide wheel having a tapered rim sized and shaped to roll in conforming contact with a carriage guiding seam of a workpiece, restricting lateral movement of the welding carriage for alignment with the carriage guiding seam. Welding equipment is mounted to the body, and has a welding torch for welding an unwelded seam of the workpiece. The welding torch is mounted to the body relative to the carriage guide wheel for disposition of a welding torch tip of the welding torch in alignment with the unwelded seam of the workpiece to weld the unwelded seam when the welding carriage moves with the carriage guide wheel rolling in the carriage guiding seam. The welding carriage has a motor coupled to drive the carriage guide wheel to propel the welding carriage.

### FIELD

The present disclosure concerns portable welding carriages, and in particular self-propelled portable welding carriages.

### BACKGROUND

Portable welding carriages are widely used in modern manufacturing processes to create welds. Welding carriages afford welders the freedom to monitor and control any number of welding parameters to provide consistent welds. Welding carriages can also be automated, freeing the welder to attend to other tasks. Welding carriages can be categorized broadly as to whether they require a track or not, i.e. are trackless. Where a track is implemented to guide the welding carriage, additional cost, time and complexity to setup the track may be incurred.

Some previous portable welding carriages include an adjustable height guide roller assembly. The guide rollers can be set to roll along a vertical member of a workpiece, or an added track provided specifically for this purpose, to guide the welding carriage as it rolls along the horizontal surface of the workpiece. Not all workpieces, however, may include or be suitably adapted to include a vertical member for guiding movement of a welding carriage along the horizontal plane of the workpiece. Thus, welding carriages implementing guide rollers to control movement of the carriage may not be suitable for some manufacturing processes.

U.S. Pat. No. 6,713,710 (“the 710 Patent”) discloses a welding apparatus with trackless movement. The apparatus is directed towards full penetration welding applications, typically required, for example, in large steel construction where turning over a workpiece to weld a second side may not be possible. It is well known in the art that full penetration welding from one side is typically achieved in one of two ways: joint penetration sensing technology for determining weld penetration or implementing a weld backing.

The 710 Patent teaches a welding apparatus implementing a weld backing for welding a butt joint along a weld line having a pre-existing gap. A connecting member extends from the welding apparatus on the top side of the workpiece, through the pre-existing gap, to the weld backing on the underside of the workpiece. In this manner, the weld backing is fixed to move synchronously with the welding apparatus as it travels along the workpiece.

The welding apparatus includes two roller units and a guide wheel unit, with each unit having a compression spring. The roller wheels generally support forward and reverse motion of the welding apparatus. The guide wheel is designed with inclined planes to contact with and roll in the pre-existing weld gap. The compression springs apply vertical pressure to the workpiece for two purposes. The first purpose is to keep the weld backing in contact with the underside of the workpiece. The second purpose is keep the guide wheel in contact with the pre-existing gap to continuously track the weld line. The welding apparatus is further connected to a stationary winch which drags the apparatus.

There remains a pressing need for further and better welding techniques including with respect to welding carriages.

### BRIEF DESCRIPTION OF THE DRAWINGS

FIG. 1 is a front perspective view of a trackless welding carriage.

FIG. 2 is a front elevation view of the trackless welding carriage of FIG. 1, having a welding torch assembly rotated to provide a clear view of a carriage guide wheel behind.

FIG. 3 is a side elevation view of the trackless welding carriage of FIG.

FIG. 4 is a rear elevation view of the trackless welding carriage of FIG. 1, having a welding torch assembly rotated to provide a clearer view of a carriage guide wheel in front.

FIG. 5 is an expanded view of a torch alignment wheel of a torch alignment assembly of the welding carriage of FIG. 1, illustrating conforming engagement with a seam of the workpiece.

FIG. 6 is an expanded view of a carriage guiding wheel of the welding carriage of FIG. 1, illustrating conforming engagement with a carriage guiding seam of the workpiece.

FIG. 7 is an expanded side elevation view of a torch alignment assembly of the welding carriage of FIG. 1.

FIG. 8 is an expanded front elevation view of the trackless welding carriage according to FIG. 1 showing the torch alignment assembly.

FIG. 9 is a perspective view of an exemplary cylindrical cargo trailer having a cylindrical container formed of longitudinal curved panels.

FIG. 10 is an end view of an exemplary container shown in FIG. 9 illustrating welding of the inner joint seams by a trackless welding carriage according to the present disclosure.

FIG. 11 is an end view of an exemplary container shown in FIG. 9 illustrating welding of the outer joint seams by a trackless welding carriage according to the present disclosure.

### DESCRIPTION

A portable welding carriage 100 for performing trackless welding is disclosed herein. The welding carriage 100 has a body 101 which may include a base 102 rollably supported by a wheeled suspension 110 having wheels 112 mounted on axles 113 for rollably supporting the welding carriage 100 on a workpiece 160 having one or more seams 162. Each seam 162 is a line or groove formed by the abutment of two or more parts of the workpiece 160. The wheels 112 may include at least one carriage guide wheel 120 sized and shaped for conformable contact with a seam 162, being a carriage guiding seam 163, of the workpiece 160. The carriage guide wheel 120 conformably contacts and rolls in the carriage guiding seam 163 sufficiently to restrict rolling engagement of the carriage guide wheel 120 in the carriage guiding seam 163, thereby restricting laterally and aligning movement of the carriage 100 to the carriage guiding seam 163 as it rolls along the surface 161 of the workpiece 160. In different embodiments, the carriage guiding seam 163 may be welded or unwelded. The restricted movement of the carriage 100 may be exploited to position at least one welding torch 132 in alignment with a seam 162. Thus, as the carriage 100 is driven along the workpiece 160, the welding torch 132 is aligned to move over the seam 162, welding the seam 162 as the welding torch 132 passes over. Alignment of the carriage 100 with the seam 162 is achieved at least in part by alignment of the carriage 100 with the restriction of rolling movement of the carriage guide wheel 120 in the carriage guiding seam 163.

The wheels 112 may include at least one support wheel 121. In some embodiments, alignment is further achieved by driving the carriage guide wheel 120 to move the carriage 100. In some embodiments the at least one support wheel 121 may be undriven so as to roll freely with the movement of the carriage 100. In some embodiments, no force external to the carriage 100 is required to drive or drag the carriage 100 in alignment with the carriage guiding seam 163. Thus, the carriage 100 may not require the costly and time consuming step of setting up tracks or other external equipment, such as a pulley apparatus, to guide movement of the carriage 100 in an alignment with a seam 162.

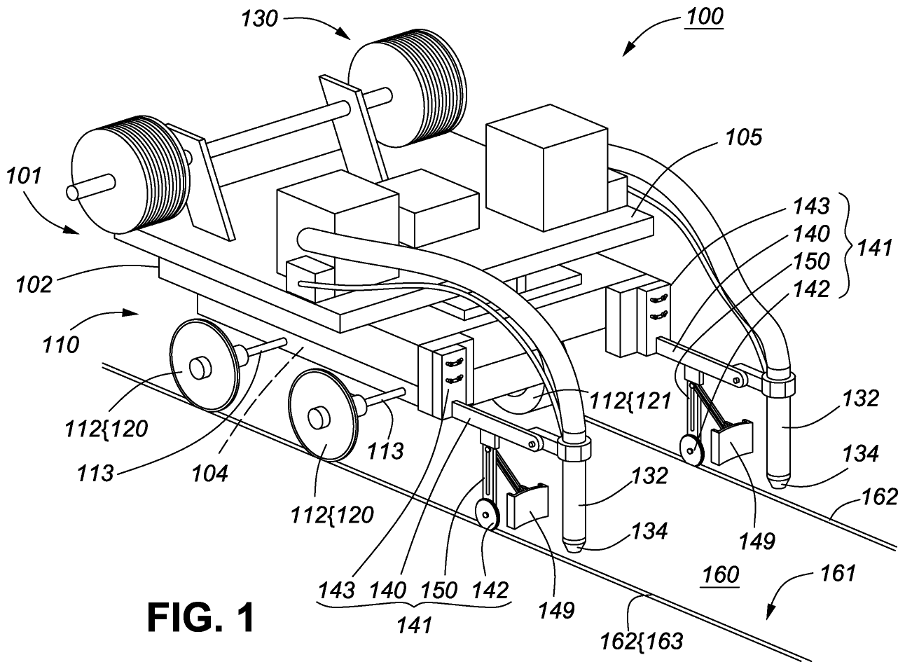

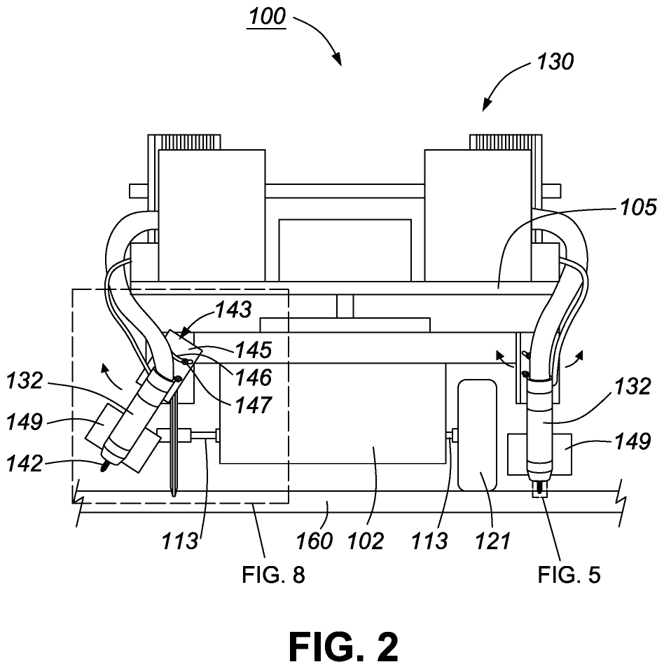

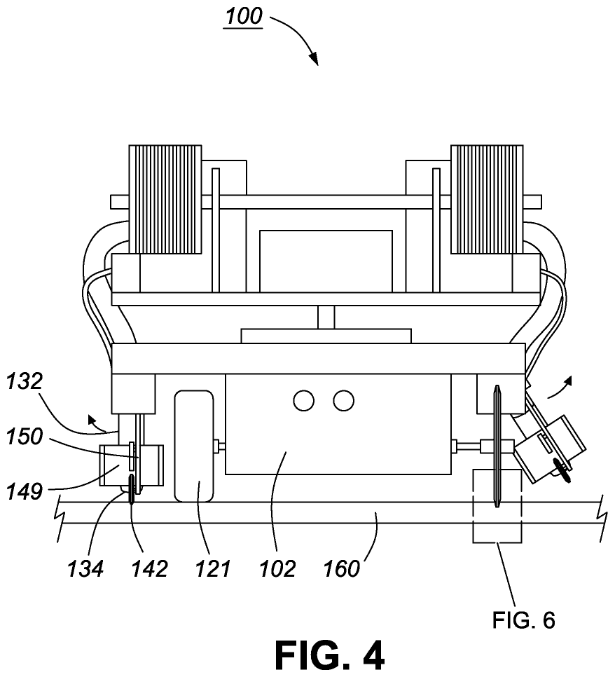

FIGS. 1 to 4 show a welding carriage 100. The carriage 100 has a base 102 to which welding equipment 130 is mounted. The welding equipment 130 may be mounted at least in part to a platform 105 mounted on and supported by the base 102. The welding equipment 130 includes at least one welding torch 132. The carriage 100 is supported by a wheeled suspension 110. The wheeled suspension 110 comprises a plurality of wheels 112 including at least one carriage guide wheel 120, which may be mounted to an axle 113. The wheels 112 may include at least one support wheel 121, which may also be mounted to an axle 113. The support wheel 121 may have a non-slip covering such as a solid or pneumatic tire, which may be made of rubber or another durable, compressible material, to provide the support wheel with traction relative to the surface 161 of the workpiece 160, and to provide vibration or impact absorption. A motor (not shown), which may be an electric motor, may be mounted to and/or enclosed in the base 102 and coupled to drive the at least one wheel 112, which may be by coupling to an axle 113, and in particular may be coupled to drive the at least one carriage guide wheel 120. The wheeled suspension 110 thus provides rolling support for the carriage 100 to travel along the surface 161 of the workpiece 160.

One or more carriage guide wheel 120 may include a generally circular disc composed of a rigid, durable material, for example metal, for example steel or aluminum, and other materials are possible. An annular rim of the carriage guide wheel 120 may be tapered, symmetrically or otherwise relative to a plane of the carriage guide wheel 120, to form a carriage guide wheel tapered rim 122. FIG. 6 shows an enlarged view of a carriage guide wheel 120 in contact with a carriage guiding seam 163 of a workpiece 160. A cross sectional profile of the carriage guide wheel tapered rim 122 of the carriage guide wheel 120 may be sized and shaped for conformable contact with the carriage guiding seam 163. Sufficient conformation between the profiles of the carriage guide wheel tapered rim 122 and carriage guiding seam 163 may restrict rolling engagement of the carriage guide wheel 120 to a direction, which may be a longitudinal direction, of the carriage guiding seam 163, and may otherwise minimize lateral movement, transverse to the rolling direction, of the carriage guide wheel 120 within the carriage guiding seam 163. Propulsion of the carriage 100 by driving the carriage guide wheel 120 may further support alignment with the carriage guiding seam 163 and may eliminate or reduce need for other driving means, and eliminate or reduce need for other means to guide alignment of the carriage 100.

In particular, superior alignment of the carriage 100 and mounted welding torch 132 with a seam 162 may be achieved if a carriage guide wheel 120 is driven to propel the carriage 100 while any support wheel 121 is undriven and turns freely with rolling movement of the carriage 100. The inventors have discovered that, surprisingly, if instead a support wheel 121 is driven, it may generate some tendency of the carriage 100 to move laterally to the seam 162 and may tend to reduce alignment of the carriage 100 with the carriage guiding seam 163 by the carriage guide wheel 120. Such tendency may include reduction of the conformable contact of the carriage guide wheel tapered rim 122 with the carriage guiding seam 163, and may progress to such extent that the carriage guide wheel 120 is lifted, or ‘skips’, out of the carriage guiding seam 163, causing the carriage 100 to lose alignment with the carriage guiding seam 163.

In operation, the motor (not shown) may drive at least one carriage guide wheel 120. The motor may be an electric motor, and a power source (not shown) may connect to the welding carriage 100, and to the motor, to power the motor. For example, a power cable may connect the welding carriage 100 to a power source. Other sources of motive power are possible.

The plurality of wheels 112 provide rolling support for the carriage 100 to travel along the surface 161 of the workpiece 160. The carriage guide wheel 120 may provide continuous rolling engagement with the carriage guiding seam 163 and restrict motion of the carriage 100 to travel in alignment with the carriage guiding seam 163. At least one welding torch 132 aligned with at least one seam 162, which may be the carriage guiding seam 163, or a different seam 162, may continuously weld the seam 162 as the carriage 100 travels in fixed alignment with the carriage guiding seam 163. In this manner, the self-driven carriage guide wheel 120 may enable automatic trackless welding of a seam 162.

The carriage guide wheel 120 and the carriage guiding seam 163 may have any dimensions appropriate to a given application, so long as the relative size and shape of the carriage guide wheel 120 and the carriage guiding seam 163 are such that the carriage guide wheel 120 conformably contacts and rolls in the carriage guiding seam 163 sufficiently to restrict rolling engagement of the carriage guide wheel 120 in the carriage guiding seam 163, thereby restricting laterally and aligning movement of the carriage 100 to the carriage guiding seam 163 as it rolls along the surface 161 of the workpiece 160.

In some embodiments, a width of the carriage guiding seam 163, which may be a width at an opening of the carriage guiding seam 163, is from 3 to 10 mm, or from 4 to 8 mm, or from 5 to 7 mm, or about 6 mm, or about 6.35 mm or about ¼″. In some embodiments, a depth of the carriage guiding seam 163 is from 1 to 5 mm, or from 2 to 4 mm, or about 3 mm, or about 3.175 mm, or about ⅛″. In some embodiments, a diameter of the carriage guide wheel 120 is from 5 to 25 cm, or from 10 to 20 cm, or from 13 to 17 cm, or about 15 cm, or about 15.24 cm, or about 6″. In some embodiments, a thickness of the carriage guide wheel 120 is from 5 to 20 mm, or from 6 to 16 mm, or from 10 to 14 mm, or about 12 mm, or about 12.7 mm, or about ½″. In some embodiments, a width and a depth of the carriage guiding seam 163 are ¼″ and ⅛″, respectively, and a diameter and a thickness of the carriage guide wheel 120 are 6″ and ½″, respectively. In order to enable the carriage guide wheel 120 conformably to contact and roll in the carriage guiding seam 163, the carriage guide wheel tapered rim 122 may have the same or substantially similar dimensions as the carriage guiding seam 163.

In some embodiments, the welding carriage 100 may include at least one torch alignment assembly 141 including a support arm 140 mounted to the base 102 and supporting the welding torch 132, positioning the welding torch 132 in alignment with a seam 162. The welding torch 132 may be positioned directly vertically above the seam 162. Alternative alignment of the welding torch 132 with the seam 162 is possible. In general, the welding torch 132 is positioned such that a welding torch tip 134 is positioned proximal the seam 162 for optimal welding of the seam 162 by the welding torch 132.

The torch alignment assembly 141 may include a support strut 150 coupled to a torch alignment wheel 142 having a torch alignment wheel rim 144 sized and shaped to conformably contact the seam 162. Sufficient conforming contact between the torch alignment wheel rim 144 and seam 162 restricts rolling engagement of the torch alignment wheel 142 for alignment along a longitudinal direction of the seam 162. The welding torch 132 may be aligned with, and positioned in close proximity to, the torch alignment wheel 142.

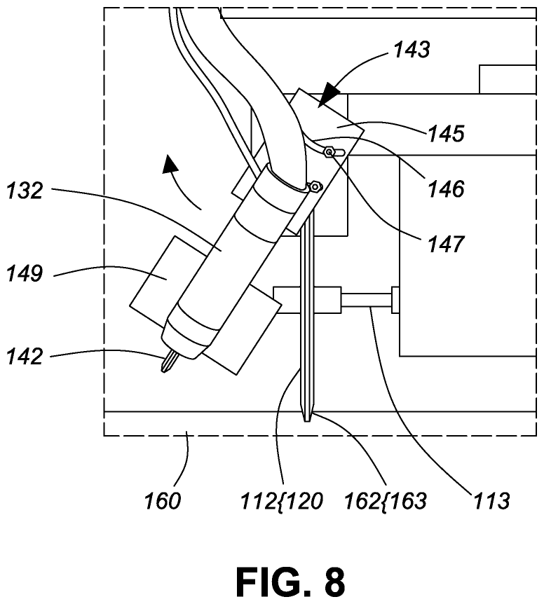

The support arm 140 may be coupled to the base 102 by a support arm mount 143 configured to permit movement of the support arm 140 relative to the base 102. For example, as shown particularly in FIG. 8, the support arm mount 143 may include a support arm mounting plate 145 having at least one slot 146 for passage of a retaining pin 147, which may include a bolt and nut, a rivet, a carriage bolt, a flanged rod, or other similar fastener, mounted to the base 102, to retain the support arm mounting plate 145 while allowing motion in a plane of the support arm mounting plate 145 involving sliding of the retaining pin 147 in the slot 146. When the slot 146 is curved, as shown in FIG. 8, the support arm mounting plate 145, and thus the support arm mount 143, may move rotatably as the retaining pin 147 slides in the slot 146, permitting the support arm mount 143 to swivel, thereby allowing the welding torch 143 to tilt, as illustrated by the arrow in the drawing. Alternatively, when the slot 146 is straight and extends transversely, the support arm mounting plate 145, and thus the support arm mount 143, may move transversely, or sideways, as the retaining pin 147 slides in the slot 146, permitting the support arm mount 143 to shift laterally, thereby allowing the welding torch 143 to move laterally. In either case, movement of the welding torch 132 may cause transverse movement of the welding torch tip 134. Such movement of the support arm mount 143 may be caused by contact force between the torch alignment wheel rim 144 and the seam 162, translated upward via the torch alignment wheel 142, thence the support strut 150, thence the support arm 140, to the support arm mount 143. In other words, as the torch alignment wheel 142 rolls in the seam 162, the contact forces which retain the torch alignment wheel 142 in the seam 162 cause, through the structure described above, adjusting movement of the welding torch tip 134 to maintain alignment thereof with the torch alignment wheel 142, which, because it positioned in close proximity to the torch alignment wheel 142, which is aligned with the seam 162, thereby maintains alignment of the welding torch tip 134 with the seam 162.

Thus, in embodiments having the torch alignment wheel 142 and assembly described above, the carriage guide wheel 120 may provide a first mechanism to maintain alignment of the carriage 100 with the carriage guiding seam 163, thereby indirectly providing alignment of the welding torch tip 134 with the seam 162 to be welded, and the torch alignment wheel 142 may provide a further, second mechanism of alignment by guiding the welding torch tip 134 directly along the seam 162, the welding torch tip 134 thereby closely tracking the seam 162 and welding it as the welding torch 132 passes over. To the extent that the seam 162 is not perfectly straight, or its cross-sectional profile is not perfectly regular along its entire length, or for any other reason that conformable rolling of the carriage guide wheel 120 in the carriage guiding seam 163 does not achieve perfect alignment of the welding torch tip 134 with the seam 162, the torch alignment assembly 141 may function to refine the alignment of the welding torch tip 134, thus achieving even closer alignment of the welding torch tip 134 with the seam 162.

The torch alignment assembly 141 may further include a shield 149 mounted to the support strut 150 (or, alternatively, to the support arm 140), and disposed between the welding torch 132, particularly the welding torch tip 134, and the torch alignment wheel 142, to protect at least the torch alignment wheel 142, and in some embodiments also other components of the torch alignment assembly 141, from damage or other change caused by heat or other radiation generated at the welding torch tip 134 and seam 162 during the welding of the seam 162.

The welding carriage 100 may have more than one welding torch 132, and correspondingly more than one torch alignment assembly 141. For example, the embodiment shown in the drawings has two welding torches 132 and correspondingly two torch alignment assemblies 141. Each welding torch 132 may be positioned to weld a corresponding seam 162, each being supported by a corresponding torch alignment assembly 141 for alignment of the corresponding welding torch tip 134 with the seam 162. Since each torch alignment assembly 141 may function independently of the other torch alignment assembly 141, each torch alignment assembly 141 may be operative to maintain independently the alignment of its corresponding welding torch tip 134 and seam 162 even when the seams 162 are not perfectly parallel, or are otherwise characterized by some irregularity, general or local, and thus in such cases where perfect positioning of the welding torches 132 relative to the base 102 and carriage guide wheel 120 might not achieve optimal alignment of the corresponding welding torch tips 134 and seams 162.

Moreover, since the torch alignment assemblies 141 may be operative for lateral movement of the corresponding welding torch tips 134 independently, but in respective alignment with the corresponding seams 162, such arrangement makes possible optimal alignment of each welding torch tip 134 with its corresponding seam 162 even when the differences in lateral movement of the welding torch tips 134 are not the result of unintended irregularity in the seams 162 or their spacing, but also when such irregularity or spacing is intentional, and part of the design of the seams 162 in the workpiece 160. While the welding carriage 100 may be advantageously useful to weld at the same time multiple seams 162 which are generally parallel, it may also be advantageously useful where the multiple seams 162 intentionally deviate from the parallel, e.g. where a lateral spacing of seams 162 increases or decreases along their length, or increases along a part of their length and decreases along a different part of their length, or otherwise varies along their length. Indeed, the provision of multiple torch alignment assemblies 141 may enable the simultaneous welding a first seam 162 that is generally straight, and a second seam that is generally irregular, for example having generally the shape of a sinusoidal wave, or a sawtooth wave, or another shape other than a straight line. Even if adjustments to the general configuration disclosed herein are required in applications where the seam 162 is not straight, the same general principles remain applicable.

In different embodiments, any suitable welding technology may be used, including, but not limited to, electrical welding, including arc welding, including shielded metal arc welding, gas metal arc welding, flux-cored arc welding, gas tungsten arc welding, or plasma arc welding.

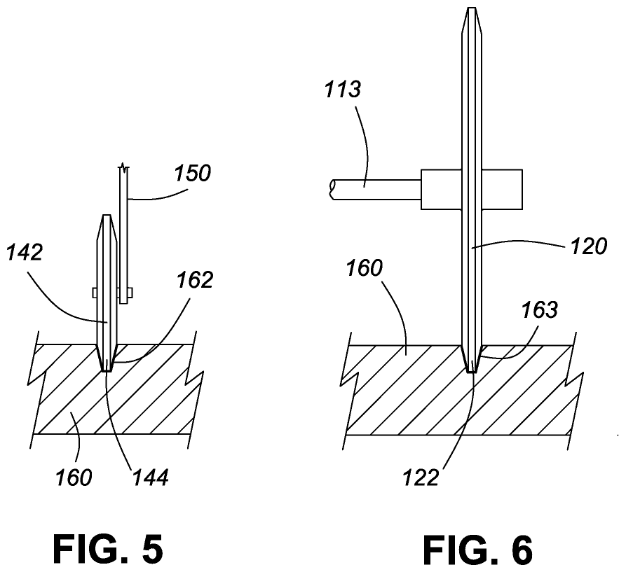

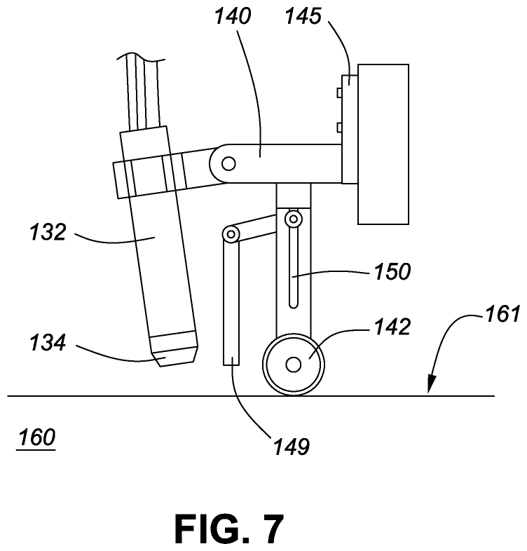

In any of the embodiments disclosed herein, the welding equipment 130, including particularly the welding torch 132, or welding torches 132, as the case may be, may be connected to a source of electrical current to power the welding equipment 130 and the welding torch(es) 132. Such connection may include at least one electrical cable operatively connected to the welding equipment 130 and/or welding torch(es) 132. In addition, the return current path may be provided by a further electrical connection, which may be by way of a further cable operatively connected to the welding equipment, and conductively contacting the workpiece. Alternatively, in any of the embodiments described herein, one or more of the carriage guide wheels 120 or torch alignment wheels 142 may function as a return current electrode. As described herein, one or more of the carriage guide wheels 120 or torch alignment wheels 142 may be formed of metal, which may be a conductive metal. As described and shown herein, and particularly including FIGS. 5 & 6, the one or more of the carriage guide wheels 120 or torch alignment wheels 142 may form intimate, conforming, and reliable contact with the corresponding seam 162 in which that wheel rolls, thereby providing reliable electrical contact. The one or more carriage guide wheels 120 or torch alignment wheels 142 may be electrically connected to the welding equipment 130 and/or source of electrical current on the current return path, and thus may be thus configured to function as the welding equipment current return electrode. As will be apparent from a consideration of FIG. 1, for example, in such case, the respective first location of each of the one or more welding torch tips 132, where welds are formed in the corresponding seam 162, and where electrical current will therefore enter the workpiece 160, and the second location of contact with the workpiece 160 of each of the one or more carriage guide wheels 120 or torch alignment wheels 142 functioning as the return current electrode as described, and thus where electrical current will exit the workpiece 160, will be separated by a fixed or minimally variable distance. As such, the return current path through the workpiece 160 may be maintained at a relatively fixed length, or variability of such path may be minimized, thereby minimizing or at least decreasing variability in the welding current flowing into the workpiece 160 at the seams 162 where the welds are formed, and thereby maximizing, or at least improving, a quality of the welds thus formed. In particular, in some embodiments, for each welding torch 132, the corresponding torch alignment wheel 142 is configured to function as the return current electrode as described. Thus, when multiple welding torches 132 and torch alignment assemblies 141 are provided, as shown in FIG. 1 for example, if a spacing between each welding torch 132, particularly the welding torch tip 134, and the corresponding torch alignment wheel 142 is the same, then each will provide the same, or approximately the same, return current path, and thus variability in the quality of the welds respectively formed by the different welding torches 132 and associated with the return current path may be eliminated, reduced, or minimized, thereby improving or optimizing consistency in the quality of the welds formed by the different torches 132.

The welding carriage is generally useful to weld any seam and advantageously provides improved alignment between the one or more welding torch tips and corresponding seams. In particular, the welding carriage is especially advantageous in applications where other structures and arrangements for supporting, aligning, and moving welding equipment is impossible, unwieldy, or otherwise disadvantageous. For example, the welding carriage may be especially advantageous where the surface of the workpiece is curved, is disposed in a constrained space, such as an enclosure, in a remote location (e.g. where supporting infrastructure is available), or in a location hazardous to humans.

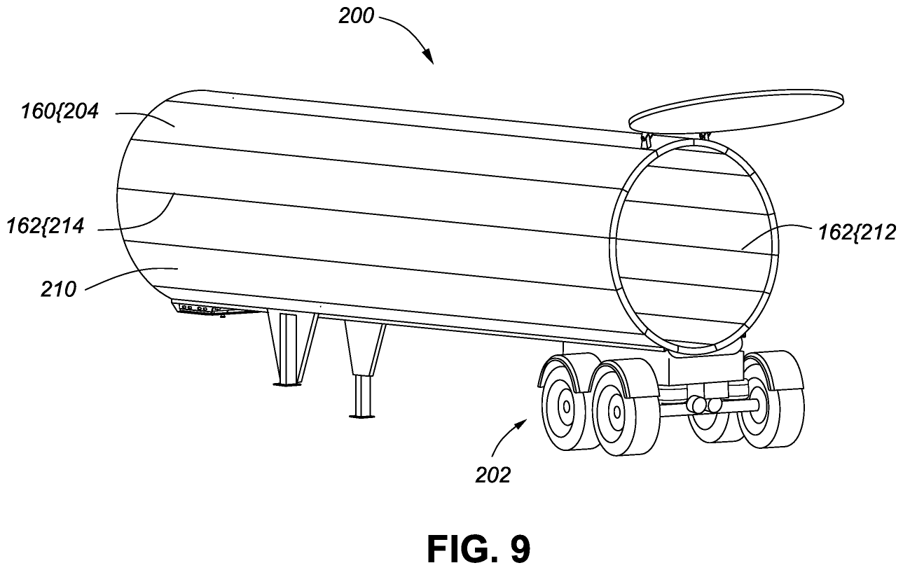

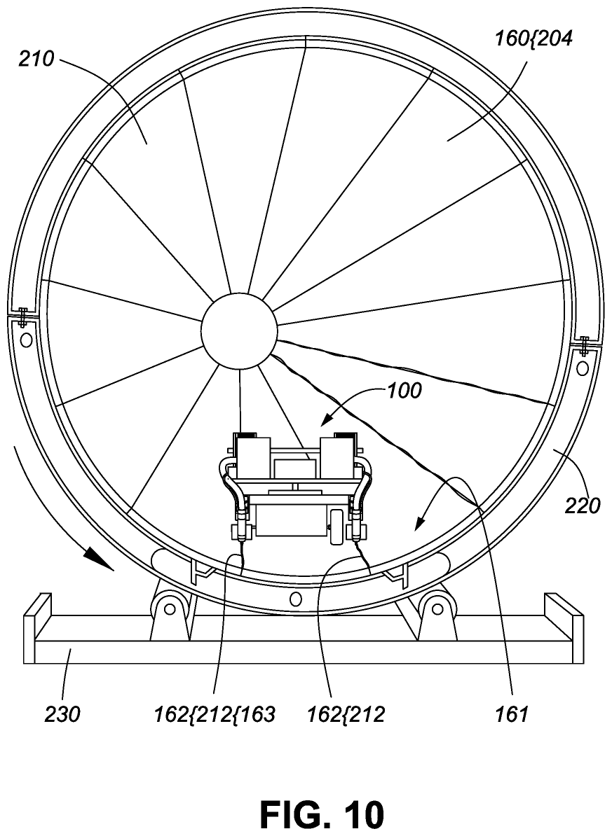

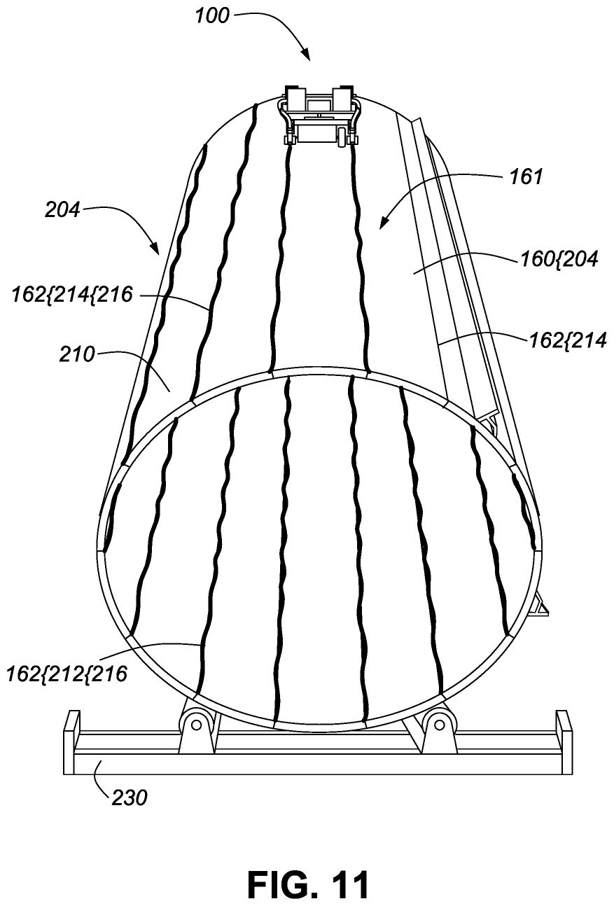

For example, FIGS. 9-11 illustrate uses of the welding carriage to weld a cylindrical cargo container 204 mounted on a wheeled suspension 202 of a cylindrical cargo trailer 200, as shown in FIG. 9. The cylindrical cargo container 204 and trailer 200 may be as disclosed in WIPO International Application No. PCT/CA2017/051538 or PCT/CA2017/051544, the entireties of which are incorporated by reference herein.

Thus, the cylindrical cargo container 204 may be formed by a plurality of arcuate panels 210, which may be extruded panels, each having the shape of a cylinder segment, which may be configured with tongue-and-groove joints, and assembled to form a complete cylinder prior to welding. The panels 210 may be formed of any suitable material, which may be a metal, which may be steel or aluminum, and have any suitable dimensions including thickness. Joints between the panels may form inner seams 212 and outer seams 214, which may be welded by use of the welding carriage 100, to form welded seams 216.

For example, by the methods disclosed in WIPO International Application No. PCT/CA2017/051544, the container 204 may be assembled using collars 220 which encircle the container 204 and constricted to compress the joints, and the cylindrical container 204 and collars 220 together may be rolled about a longitudinal axis of the container 204 using a rolling apparatus 230 such as a tank roller. The welding carriage 100 may be used to weld the inner seams 212, by placing the welding carriage 100 at one end of the container 204 with the one or more carriage guide wheel 120 resting and engaged in an inner seam 212, and each torch alignment wheel 142 also resting and engaged in an inner seam 212. If the welding carriage 100 has two welding torches 132 and corresponding torch alignment assemblies 141, their respective torch alignment wheels 142 may be engaged in corresponding inner seams 212 for alignment with corresponding welding torch tips 134. One of the torch alignment wheels 142 may ride in the same inner seam 212 as the carriage guide wheel 120. Thus placed, the welding carriage 100 may be moved down the length of the container 204, which may be by driving the at least one carriage guide wheel 120, which may be by the motor 104, while the inner seams 212 with welding torch tips 134 positioned for alignment with the inner seams 212 are welded to form welded seams 216 using the welding equipment 130 including the welding torches 132 and welding torch tips 134. Once one or more inner seams 212 is welded in a first pass, the welding carriage 100 may be lifted, or otherwise repositioned, to permit rolling rotation of the container 204 to bring adjacent a bottom position one or more further inner seams 212 to be welded, and the welding carriage 100 may be replaced for welding of the inner seams 212 as described above. In this manner, a plurality or all of the inner seams 212 of the container 204 may be welding using the welding carriage 100.

Having used the welding carriage 100 to weld the inner seams 212, the collars 220 may be removed, and the welding carriage 100 may be used to weld the outer seams 214 in a similar manner. The welding carriage 100 may be placed at one end atop the container 204 with the one or more carriage guide wheel 120 resting and engaged in an outer seam 214, and each torch alignment wheel 142 also resting and engaged in an outer seam 214. If the welding carriage 100 has two welding torches 132 and corresponding torch alignment assemblies 141, their respective torch alignment wheels 142 may be engaged in corresponding outer seams 214 for alignment with corresponding welding torch tips 134. One of the torch alignment wheels 142 may ride in the same outer seam 214 as the carriage guide wheel 120. Thus placed, the welding carriage 100 may be moved down the length of the container 204, which may be by driving the at least one carriage guide wheel 120, which may be by the motor 104, while the outer seams 214 with welding torch tips 134 positioned for alignment with the outer seams 214 are welded to form welded seams 216 using the welding equipment 130 including the welding torches 132 and welding torch tips 134. Once one or more outer seams 214 is welded in a first pass, the welding carriage 100 may be lifted, or otherwise repositioned, to permit rolling rotation of the container 204 to bring adjacent a top position one or more further outer seams 214 to be welded, and the welding carriage 100 may be replaced for welding of the outer seams 214 as described above. In this manner, a plurality or all of the outer seams 214 of the container 204 may be welding using the welding carriage 100.

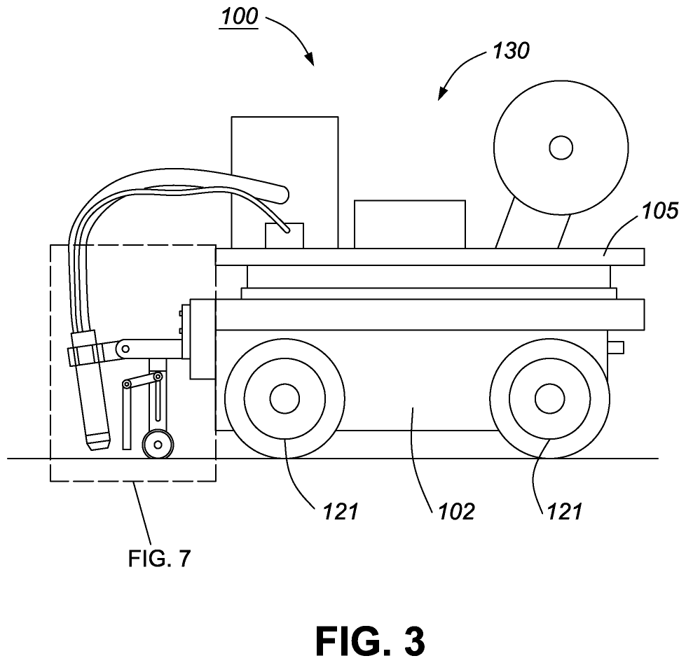

For either or both of the inner seams 212 and outer seams 214, an entire length may be welded without external equipment to move the welding carriage 100, while the alignment mechanisms described herein achieve optimal alignment of the welding torch tips 134 to weld the seams. Moreover, when the at least one welding torch 132 is mounted as shown particularly in FIG. 3, such that the welding torch tip 134 is disposed at an end of the welding carriage 100 beyond both the torch alignment wheel 142 and the wheels 112, then the welding carriage 100 may be used advantageously to weld the seam 162 to the very end of the seam 162. Moreover, in each case described above, the seams 162 are welding from above, with the welding torch 132 disposed substantially vertically, thus producing a superior weld, as is known to be produced when the welding torch 132 is disposed vertically above the seam 162 as opposed to below the seam 162 or at an oblique angle. Moreover, when the welding carriage 100 is used to weld the outer seams 214 and is thus placed atop the container 204 as described above, the engagement of the carriage guide wheel 120 with the carriage guiding seam 163 may function to stabilize the welding carriage 100 atop the container 204, and to prevent or reduce lateral movement. In particular, when the welding carriage 100 is propelled by driving the carriage guide wheel 120 using the motor 104, the chances of the carriage guide wheel 120 disengaging from the carriage guiding seam 163 may be reduced, thus reducing the chances of the welding carriage 100 falling off of the container 204.

The following are non-limiting examples of embodiments of the subject matter disclosed herein.

Example 1. A welding carriage, comprising: a body supported by a wheeled suspension comprising a plurality of wheels comprising a carriage guide wheel having a tapered rim sized and shaped to roll in conforming contact with a carriage guiding seam of a workpiece; and welding equipment mounted to the body, the welding equipment comprising a welding torch for welding an unwelded seam of the workpiece.

Example 2. The welding carriage according to Example 1, wherein the unwelded seam is the carriage guiding seam.

Example 3. The welding carriage according to Example 1, wherein the unwelded seam is different from the carriage guiding seam.

Example 4. The welding carriage according to any one of Examples 1 to 3, wherein: the carriage guide wheel is a first carriage guide wheel; the tapered rim is a first tapered rim; the wheeled suspension further comprises a second carriage guide wheel having a second tapered rim sized and shaped to roll in conforming contact with the carriage guiding seam of the workpiece.

Example 5. The welding carriage according to any one of Examples 1 to 4, wherein the conforming contact restricts lateral movement of the welding carriage for alignment with the carriage guiding seam.

Example 6. The welding carriage according to any one of Examples 1 to 5, wherein the welding torch is mounted to the body relative to the carriage guide wheel for disposition of a welding torch tip of the welding torch in alignment with the unwelded seam of the workpiece.

Example 7. The welding carriage according to any one of Examples 1 to 6, configured to weld the unwelded seam when the welding carriage moves with the carriage guide wheel rolling in the carriage guiding seam.

Example 8. The welding carriage according to any one of Examples 1 to 7 further comprising a motor coupled to drive the carriage guide wheel or a support wheel of the wheeled suspension to move the welding carriage with the carriage guide wheel rolling in the carriage guiding seam.

Example 9. The welding carriage according to Example 8, wherein the motor is coupled to drive the carriage guide wheel.

Example 10. The welding carriage according to Example 9 when dependent on Example 4, wherein the motor is coupled to drive the first carriage guide wheel and the second carriage guide wheel.

Example 11. The welding carriage according to Example 9 or 10, wherein the support wheel is undriven by the motor.

Example 12. The welding carriage according to any one of Examples 1 to 11, wherein the motor is mounted on or in the body.

Example 13. The welding carriage according to any one of Examples 1 to 12 when dependent on Example 3, further comprising a torch alignment assembly mounted to the body, wherein the welding torch is mounted to and supported by the torch alignment assembly, and wherein the torch alignment assembly is configured to align the welding torch with the unwelded seam.

Example 14. The welding carriage according to Example 9 when dependent on Example 6, wherein the torch alignment assembly is configured to align the welding torch tip with the unwelded seam.

Example 15. The welding carriage according to Example 13 or 14, wherein the torch alignment assembly comprises a support arm coupled to suspend the welding torch over the unwelded seam, and a torch alignment wheel having a torch alignment wheel rim sized and shaped to roll in conforming contact with the unwelded seam, wherein the torch alignment wheel is coupled to move the support arm and welding torch in alignment with the unwelded seam.

Example 16. The welding carriage according to Example 15, wherein the support arm is coupled at a support arm first end to a support arm mount and at a support arm second end to the welding torch, wherein the support arm mount is mounted to the body to permit movement of the support arm and welding torch in alignment with the unwelded seam.

Example 17. The welding carriage according to Example 16, wherein the support arm mount comprises a support arm mounting plate comprising at least one slot sized and shaped to receive a retaining pin mounted to the body, the retaining pin configured to retain the support arm mounting plate in contact with the body while permitting movement of the support arm mounting plate by relative movement of the slot about the retaining pin.

Example 18. The welding carriage according to any one of Examples 13 to 17, wherein the torch alignment assembly aligns the welding torch with the unwelded seam by movement of the welding torch laterally relative to a longitudinal direction of the unwelded seam.

Example 19. The welding carriage according to any one of Examples 1 to 18 wherein: the unwelded seam is a first unwelded seam; and the welding equipment further comprises a second welding torch for welding a second unwelded seam of the workpiece.

Example 20. The welding carriage according to Example 19 when dependent on Example 13, wherein: the torch alignment assembly is a first torch alignment assembly; the welding carriage further comprises a second torch alignment assembly mounted to the body; the second welding torch is mounted to and supported by the second torch alignment assembly; and the second torch alignment assembly is configured to align the second welding torch with the second unwelded seam.

Example 21. The welding carriage according to any one of Examples 1 to 20, wherein a width of the carriage guiding seam is from 3 to 10 mm.

Example 22. The welding carriage according to any one of Examples 1 to 21, wherein a depth of the carriage guiding seam is from 1 to 5 mm.

Example 23. The welding carriage according to any one of Examples 1 to 22, wherein a diameter of the carriage guide wheel 120 is from 5 to 25 cm.

Example 24. The welding carriage according to any one of Examples 1 to 23, wherein a thickness of the carriage guide wheel is from 5 to 20 mm.

Example 25. A kit for modifying a welding carriage, the kit comprising: a carriage guide wheel having a tapered rim sized and shaped to roll in conforming contact with a carriage guiding seam of a workpiece; and instructions for modifying the welding carriage to have the carriage guide wheel.

In the preceding description, for purposes of explanation, numerous details are set forth in order to provide a thorough understanding of the embodiments. However, it will be apparent to one skilled in the art that these specific details are not required. In particular, it will be appreciated that the various additional features shown in the drawings are generally optional unless specifically identified herein as required. The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1-27. (canceled)

28. A welding carriage, comprising:
a body supported by a wheeled suspension comprising a plurality of wheels comprising a carriage guide wheel having a tapered rim sized and shaped to roll in conforming contact with a carriage guiding seam of a workpiece; and
welding equipment mounted to the body, the welding equipment comprising a welding torch for welding an unwelded seam of the workpiece.

29. The welding carriage according to claim 28, wherein the unwelded seam is the carriage guiding seam.

30. The welding carriage according to claim 28, wherein the unwelded seam is different from the carriage guiding seam.

31. The welding carriage according to claim 28, wherein:
the carriage guide wheel is a first carriage guide wheel;
the tapered rim is a first tapered rim; and
the wheeled suspension further comprises a second carriage guide wheel having a second tapered rim sized and shaped to roll in conforming contact with the carriage guiding seam of the workpiece.

32. The welding carriage according to claim 28, wherein the conforming contact restricts lateral movement of the welding carriage for alignment with the carriage guiding seam.

33. The welding carriage according to claim 28, wherein the welding torch is mounted to the body relative to the carriage guide wheel for disposition of a welding torch tip of the welding torch in alignment with the unwelded seam of the workpiece.

34. The welding carriage according to claim 28, configured to weld the unwelded seam when the welding carriage moves with the carriage guide wheel rolling in the carriage guiding seam.

35. The welding carriage according to claim 28 further comprising a motor coupled to drive the carriage guide wheel or a support wheel of the wheeled suspension to move the welding carriage with the carriage guide wheel rolling in the carriage guiding seam.

36. The welding carriage according to claim 35, wherein the motor is coupled to drive the carriage guide wheel.

37. The welding carriage according to claim 36, wherein:
the carriage guide wheel is a first carriage guide wheel;
the tapered rim is a first tapered rim;
the wheeled suspension further comprises a second carriage guide wheel having a second tapered rim sized and shaped to roll in conforming contact with the carriage guiding seam of the workpiece; and
the motor is coupled to drive the first carriage guide wheel and the second carriage guide wheel.

38. The welding carriage according to claim 36, wherein the support wheel is undriven by the motor.

39. The welding carriage according to claim 35, wherein the motor is mounted on or in the body.

40. The welding carriage according to claim 28, further comprising a torch alignment assembly mounted to the body, wherein the welding torch is mounted to and supported by the torch alignment assembly, and wherein the torch alignment assembly is configured to align the welding torch with the unwelded seam.

41. The welding carriage according to claim 40, wherein the unwelded seam is different from the carriage guiding seam.

42. The welding carriage according to claim 40, wherein the torch alignment assembly comprises a support arm coupled to suspend the welding torch over the unwelded seam, and a torch alignment wheel having a torch alignment wheel rim sized and shaped to roll in conforming contact with the unwelded seam, wherein the torch alignment wheel is coupled to move the support arm and welding torch in alignment with the unwelded seam.

43. The welding carriage according to claim 42, wherein the torch alignment wheel is configured to conductively contact the unwelded seam and is electrically coupled to the welding equipment to function as a return current electrode for the welding torch.

44. The welding carriage according to claim 42, wherein the support arm is coupled at a support arm first end to a support arm mount and at a support arm second end to the welding torch, wherein the support arm mount is mounted to the body to permit movement of the support arm and welding torch in alignment with the unwelded seam.

45. The welding carriage according to claim 44, wherein the support arm mount comprises a support arm mounting plate comprising at least one slot sized and shaped to receive a retaining pin mounted to the body, the retaining pin configured to retain the support arm mounting plate in contact with the body while permitting movement of the support arm mounting plate by relative movement of the slot about the retaining pin.

46. The welding carriage according to claim 40, wherein the torch alignment assembly aligns the welding torch with the unwelded seam by movement of the welding torch laterally relative to a longitudinal direction of the unwelded seam.

47. The welding carriage according to claim 28, wherein:
the unwelded seam is a first unwelded seam; and the welding equipment further comprises a second welding torch for welding a second unwelded seam of the workpiece.

48. The welding carriage according to claim 47, further comprising a torch alignment assembly mounted to the body, wherein the welding torch is mounted to and supported by the torch alignment assembly, and wherein the torch alignment assembly is configured to align the welding torch with the unwelded seam, wherein:
the torch alignment assembly is a first torch alignment assembly;
the welding carriage further comprises a second torch alignment assembly mounted to the body;
the second welding torch is mounted to and supported by the second torch alignment assembly; and
the second torch alignment assembly is configured to align the second welding torch with the second unwelded seam.

49. The welding carriage according to claim 28, wherein a width of the carriage guiding seam is from 3 to 10 mm.

50. The welding carriage according to claim 28, wherein a depth of the carriage guiding seam is from 1 to 5 mm.

51. The welding carriage according to claim 28, wherein a diameter of the carriage guide wheel is from 5 to 25 cm.

52. The welding carriage according to claim 28, wherein a thickness of the carriage guide wheel is from 5 to 20 mm.

53. The welding carriage according to claim 28, wherein the carriage guide wheel is configured to conductively contact the carriage guiding seam and is electrically coupled to the welding equipment to function as a return current electrode.

54. A kit for modifying an original welding carriage to produce the welding carriage according to claim 28, the kit comprising:
the carriage guide wheel having the tapered rim sized and shaped to roll in conforming contact with the carriage guiding seam of the workpiece; and
instructions for modifying the original welding carriage to have the carriage guide wheel.
